(19) United States
(12) Patent Application Publication
(10) Pub. No.: US 2010/0228960 A1
(43) Pub. Date: Sep. 9, 2010

(54) VIRTUAL MEMORY OVER BASEBOARD MANAGEMENT CONTROLLER

(76) Inventors: Shih-Yuan Huang, Keelung City (TW); Shang-Ching Hung, Gueishan Township (TW)

Correspondence Address: Patterson & Sherldan - ATEN, 3040 Post Oak Boulevard, Suite 1500, Houston, TX, 77056, US

(21) Appl. No.: 12/399,922

(22) Filed: Mar. 6, 2009

(51) Int. Cl. G06F 9/00; G06F 15/177

(52) U.S. Cl. 713/100

(57) ABSTRACT

Embodiments of the present invention generally relate to techniques for updating a BIOS image stored in a computer system. The BIOS image is stored in a flash memory and updated over an embedded system, such as a baseboard management controller (BMC). In one embodiment, a method for updating a BIOS image on a computer system includes receiving, by a service processor, an updated BIOS image over a communications channel, moving a current BIOS image from a first storage location to a second storage location, moving the updated BIOS image to the first storage location, receiving, from a chipset coupled to the service processor, a request to access the BIOS image on the server system, and directing, by the service processor, the request to access the BIOS image to the BIOS image in the second storage location.

### BACKGROUND

1. Field of the Invention

Embodiments of the present invention generally relate to techniques for updating a BIOS image. More particularly, embodiments of the invention relate to techniques for updating a BIOS image using a baseboard management controller (BMC).

2. Description of the Related Art

As the number of computer servers used by businesses has increased substantially, techniques have been developed for remotely managing the operation of such servers. Without such techniques, when a remote server, i.e., a server not physically located on the acting person's “desk”, malfunctions, troubleshooting the remote server requires a skilled person (i.e. an administrator) to be brought to the server. For an organization managing servers in multiple locations, this may require having individuals available at each location where a server resides. For large organizations, this may become very inconvenient. The Intelligent Platform Management Interface (IPMI) specification maintained by Intel®, NEC®, Hewlett-Packard®, and Dell® corporations defines a standard interface to hardware used for monitoring characteristics of a server, e.g., temperature, voltage, power supplies and fan status, etc.

An IPMI-enabled system monitors and stores platform information in a common format (as defined by the IPMI standard) which can be accessed by an administrator at a remote site using server management software. Further, an IPMI-enabled system allows an administrator to control functions of the server independently from the server's main processor, basic input output system (BIOS), and operating system (OS), typically through the use of a service processor, e.g., a baseboard management controller (BMC). Moreover, the IPMI can operate in different firmware and hardware platforms at the same time. That is, the IPMI may be used to monitor the status of multiple servers, as well as monitor an event diary log, shutdown and restart a particular server using system control functions, send an alarm for an event and auto-system control (such as failure of power). For instance, an I²C digital sensor connected to the IPMI can detect system voltage, temperature and speed of the fan of the remote server in real-time and determine whether these system elements are operating outside of a predetermined range.

Thus, the IPMI and BMC conveniently allow the administrator to monitor the servers remotely using a local area network (LAN) or a serial modem. When a critical event occurs, the administrator can execute a fault correction procedure immediately. For example, if the temperature of the server exceeds a specified limit, fan speed may be increased to reduce it. If the condition is critical, in addition to recording data for future inquiry, the BMC may be configured to inform the administrator—who may be far from the server—using messages sent over the LAN at the same time.

While an IPMI-enabled system allows an administrator to perform a variety of server monitoring and management functions remotely, it still has significant limitations. For example, certain system upgrades, such as updating a BIOS image, may still require a person be physically in the same room of the machine. In such cases, a system administrator may have to travel to wherever a given machine is located in order to flash a BIOS image on a machine.

### SUMMARY OF THE INVENTION

Embodiments of the present invention generally relate to techniques for updating a BIOS image stored in a computer system over an embedded system, such as a baseboard management controller (BMC). One embodiment of the invention includes a method for updating a BIOS image on a server system. The method may generally include One embodiment of the invention includes a method for updating a BIOS image on a server system. The method may generally include receiving, by a service processor, an updated BIOS image over a communications channel, moving a current BIOS image from a first storage location to a second storage location, moving the updated BIOS image to the first storage location, receiving, from a chipset coupled to the service processor, a request to access the BIOS image on the server system and directing, by the service processor, the request to access the BIOS image to the BIOS image in the second storage location.

In a particular embodiment, the communications channel is an IPMI channel used to transmit IPMI messages to the service processor. For example, the IPMI channel may comprise an IPMI over LAN channel, a UART (i.e., a serial connection) channel, a KCS (keyboard control style) channel, or an IPMB (Intelligent Platform Management Bus) channel. The service processor itself may comprise a baseboard management controller (BMC).

The storage locations may be within a variety of different storage units, comprising, e.g., a region of flash memory, a region of NVRAM memory, and a region of SDRAM memory.

Another embodiment of the invention includes a computer-readable storage medium containing a program which, when executed, performs an operation for updating a BIOS image on a server system. The operation may generally include receiving an updated BIOS image over a communications channel, moving a current BIOS image from a first storage location to a second storage location, moving the updated BIOS image to the first storage location, receiving a request to access the BIOS image on the server system, and directing the request to access the BIOS image to the BIOS image in the second storage location.

Still another embodiment of the invention includes a computer system includes a memory storing a current BIOS image, a processor, and a service processor containing a firmware image configured to perform an operation for updating the current BIOS image on the computer system, and at least one IPMI communications channel configured to communicate with the service processor to supply an updated BIOS image to the service processor over the IPMI channel. The operation performed by the firmware image may generally comprise receiving an updated BIOS image over a communications channel, moving a current BIOS image from a first storage location to a second storage location, moving the updated BIOS image to the first storage location, receiving a request to access the BIOS image on the server system, and directing the request to access the BIOS image to the BIOS image in the second storage location.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

FIG. 1 is a block diagram illustrating a management system configured to update a BIOS on a computer system, according to one embodiment of the invention.

FIG. 2 is a schematic block diagram further illustrating the computer system first shown in FIG. 1, according to one embodiment of the invention.

FIG. 3 is flow diagram illustrating a method for updating a BIOS on a server system, according to one embodiment of the invention.

FIG. 4 is a flow diagram illustrating a method for accessing BIOS functions and/or data using a storage location, according to one embodiment of the invention.

It is to be noted, however, that the appended drawings illustrate only typical embodiments of this invention and are therefore not to be considered limiting of its scope, for the invention may admit to other equally effective embodiments. Additionally, to facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to techniques for updating a BIOS image stored in a computer system. In one embodiment, the BIOS image is stored in a flash memory and updated over an embedded system, such as a baseboard management controller (BMC). For example, the BMC may be accessed using one of a variety of IPMI channels, such as IPMI over LAN, over a UART (i.e., a serial connection), over a KCS (keyboard control style) communications channel, or an IPMB (Intelligent Platform Management Bus). In one embodiment, an administrator may interact with management software to supply an updated BIOS image to a server. The management software may exchange IPMI messages with a BMC running on the server. As the IPMI interface provided by the BMC may be accessed over a LAN, the administrator may update a BIOS image from a location remote to the server. Of course, the LAN (and other) IPMI channels may be used in cases where the administrator and the server are in a common location.

In either case, the administrator supplies the updated BIOS image to the BMC. In response, the BMC may be configured to identify a location of a current BIOS image. For example, a server may include a dedicated storage container (e.g., a memory such as a NVRAM, a flash, an EEPROM, a RAM, a SDRAM, etc) used to store the BIOS image. Further, the BMC may copy the current BIOS image from the dedicated storage container to a temporary location (e.g., a region of system memory such as a NVRAM, a flash, an EEPROM, a RAM, a SDRAM, etc). Once copied, requests made by a server, such as a server chipset, to access BIOS functions or data are sent to the BIOS image stored in the temporary location. That is, the copied BIOS image provides a memory, such as virtual memory, for BIOS operations carried out by the server. Further still, the updated BIOS image may be stored in the BIOS storage container. In one embodiment, once the updated BIOS is stored in the BIOS storage container, requests for BIOS information and/or data may be directed to the updated BIOS. Alternatively, the server may continue to operate using the BIOS in the temporary location until being restarted. Doing so may allow the server to be updated at one time and continue using the original BIOS until the server is restarted at a convenient time.

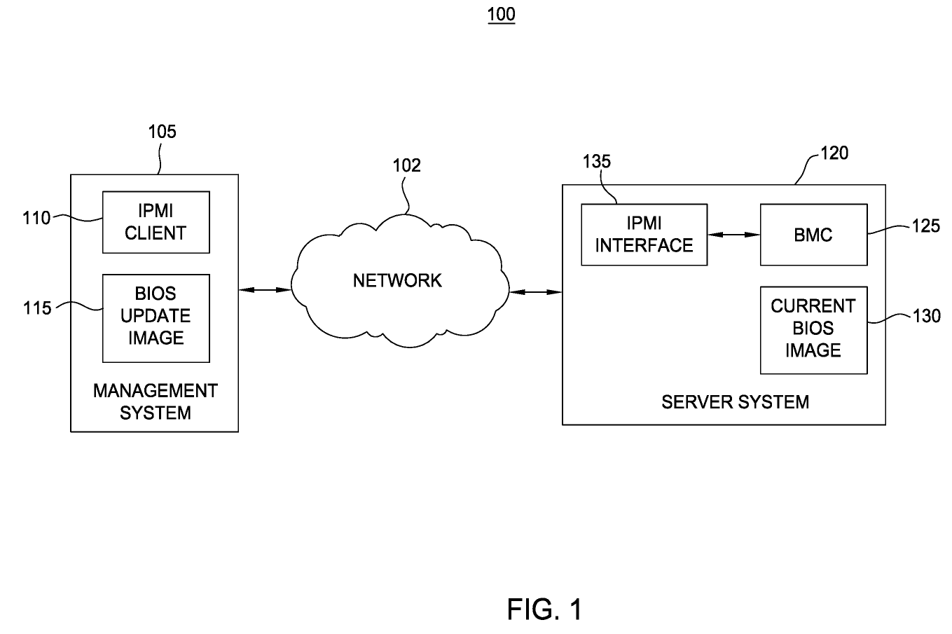

One embodiment of the invention is implemented as a program product for use with a computer system such as, for example, the computing environment 100 shown in FIG. 1 and described below. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention.

FIG. 1 is a block diagram illustrating a computing environment 100 configured to update a BIOS on a server system over an embedded system according to one embodiment of the invention. In one embodiment, the computer system illustrated in computing environment 100 may include existing computer systems, e.g., a desktop computer, a server computer, a laptop computer, a tablet computer, and the like. The computing environment 100 illustrated in FIG. 1, however, is merely an example of one computing environment. Embodiments of the present invention may be adapted for use with other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language and may be adapted to take advantage of new computing systems as they become available. Further still, while described relative to widely used IPMI standard, embodiments of the invention may be adapted for use with other interfaces used to communicate with a service processor, whether currently available or later developed.

As shown, the computing environment 100 includes a management system 105, an IPMI client 110, and a BIOS update image 115. Illustratively, the management system 105 includes an IPMI client 110 and a BIOS update image 115. The management system 105 may also include a central processing unit (CPU) connected to a memory accessible via a bus (not shown). The IPMI client 110 provides a software tool configured to communicate with a service processor (e.g., baseboard management controller (BMC) 125) using the IPMI interface 135. Intelligent Platform Management capabilities are commonly used to provide enterprise-class management for high-availability systems. The term “Intelligent Platform Management” generally refers to autonomous monitoring and recovery features implemented directly in platform management hardware and firmware (e.g., the hardware and firmware of server system 120). Generally, platform status information can be obtained and recovery actions initiated under situations where system management software and normal “in-band” management mechanisms are unavailable, and even when the computer is in a powered down state.

In this example, IPMI client 105 communicates with the IPMI interface 135 and the BMC 125 over a network 102. The network 102 may be a local area network connecting management system 105 and server system 120 at a single facility, but may also be a larger network such as the internet. In the latter case, network 102 allows IPMI client 110 to access the IPMI interface 135 and BMC 125 from virtually any location.

The server system 120 may include a central processing unit (CPU) connected to a memory accessible via a bus (not shown). Illustratively, the server system 120 includes the IPMI interface, BMC 125, and a current BIOS image 130. In one embodiment, the BMC 125 may be configured to receive a command from IPMI client 105 indicating that a BIOS update process should be performed. In such a case, the current BIOS image 130 may be moved from a regular storage location (e.g., an EEPROM or other non-volatile memory storage container) and stored in a temporary location (e.g. a region of SDRAM). The BMC 125 may be further configured to allow server system 120 to operate using the current BIOS image 130 stored in the temporary location. That is, the regular access of the BIOS in the server system 120 may continue uninterrupted. The IPMI client 105 sends the BIOS update image 115 to the BMC 125 using the IPMI interface 135. Once received, the BMC 125 may store the updated BIOS image 115 in the regular storage location (e.g., the EEPROM).

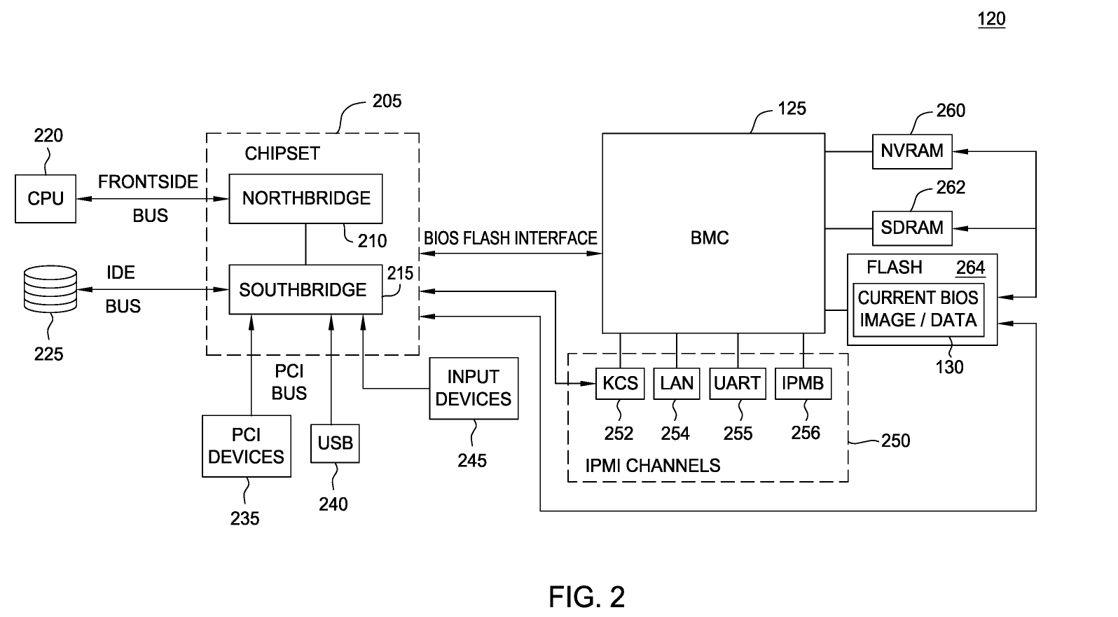

FIG. 2 is an schematic diagram further illustrating the server system 120 first shown in FIG. 1, according to one embodiment of the invention. As shown, the server system 120 includes a chipset 205, the BMC 125, an NVRAM 260, an SDRAM 262, and a flash 264. In this embodiment, the flash 263 is for storing the current BIOS image 130 and associated data (e.g., the actual BIOS settings). Of course, one of ordinary skill in the art will recognize that the schematic diagram illustrating server system 120 is simplified to highlight aspects of the present invention and can be more simplified to include fewer elements.

Illustratively, the chipset 205 includes a northbridge 210 connected to a CPU 220 over a front side bus. CPU 220 is included to be representative of a single CPU, multiple CPUs, a single CPU having multiple processing cores, and the like.

Chipset 205 also includes a southbridge 215 connected to storage devices 225 over an IDE bus. Storage devices 225 store application programs and data for use by server system 120. Examples of storage devices 225 include one or more hard-disk drives, optical media and the like. Southbridge 215 may also be connected to PCI devices 235, to a universal serial bus (USB) 240, and input devices 245, such as a mouse, keyboard and monitor, as well as a network interface used to connect server system 120 to an Ethernet network.

Illustratively, chipset 205 is also connected to IPMI channels used to communicate with the BMC 125. As shown, IPMI channels 250 include a KCS (keyboard control style) channel 252, a LAN channel 254, a UART 255, and an IPMB (Intelligent Platform Management Bus) channel 256. Thus, any of the channels 250 may be used to commutate with the BMC 125 according to the IPMI standard. Further, BMC 125 is connected to the NVRAM 260, SDRAM 262 and Flash 264. Of course one of skill in the art will recognize that not all systems include all three kinds of memory (SDRAM, NVRAM, and flash).

As described herein, the BMC may move the current BIOS image 130 from the flash 264 and store in a temporary location, e.g., SDRAM 262, thereby providing a virtual memory, herein a virtual flash, to the chipset 205. Further, the BMC 125 may receive an updated BIOS image over one of the IPMI channels 250 (e.g., LAN channel 254) and store the updated image in the flash 264. In other embodiments, the updated BIOS image received can be stored in the NVRAM 260, or in the SDRAM 262. Thus, embodiments of the invention allow an administrator to update the BIOS image of server system 120 from a remote location, without disrupting the ongoing operations of the server system 120.

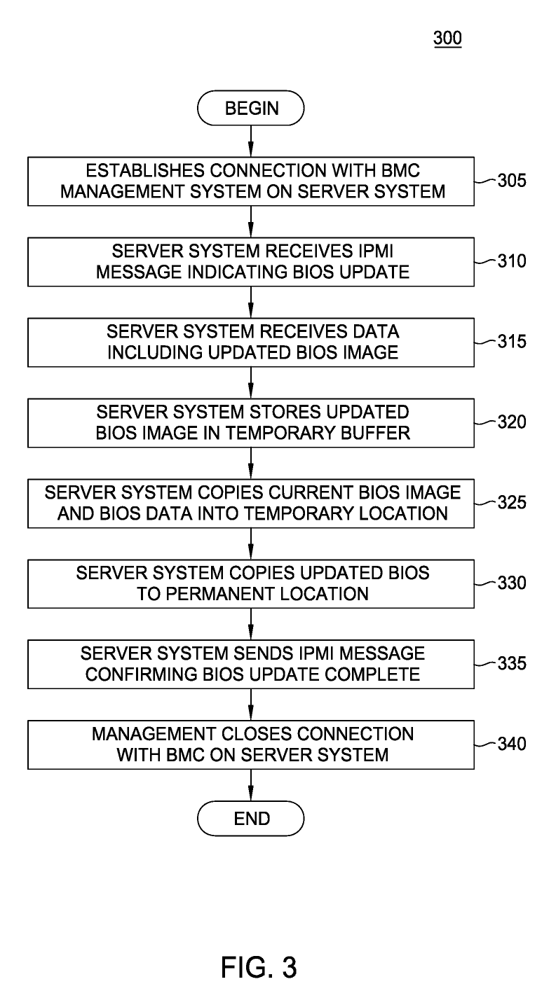

FIG. 3 is flow diagram illustrating a method 300 for updating a BIOS on a computer system using a virtual memory update over a BMC. As shown, the method 300 begins at step 305 where a connection is established with a service processor on a server system. For example, an administrator may interact with the IPMI client 110 to connect to a BMC using IPMI over LAN (or other IPMI communication channel). Please note that the IMPI message is not limited to the OEM IPMI commands and the IPMI message may include all data transferred between the management system and the BMC in the server system.

At step 310, the BMC may receive an IPMI message indicating that a BIOS update process should be performed. And at step 315, the BMC may receive data including an updated BIOS image. As described above, the updated BIOS image may be received over any available IPMI communications channel. Once received, the BMC may store the updated BIOS image in a temporary buffer (step 320). At step 325, the BMC may copy the current BIOS image used to boot the server system from its regular location to a temporary location (e.g., a region of system memory, SDRAM, or other temporary location). At step 330, the BMC may copy the updated BIOS image a permanent location, i.e., to the location from which the current BIOS image was moved at step 325. In an alternative embodiment, the flash memory storing the original BIOS image may be large enough to store both the original BIOS image and the updated BIOS image. In such cases, step of copying the original BIOS image to a temporary location may be performed within the larger flash memory.

At step 335, the BMC may send an IPMI message confirming that the BIOS update operation has been performed. For example, a status message indicating that the update has been completed may be sent to the IPMI client 110. Once complete, at step 340 the connection the BMC (established at step 305) may be closed. Of course, the connection could first be used to perform the IPMI management functions, e.g., monitoring system status or rebooting the server system.

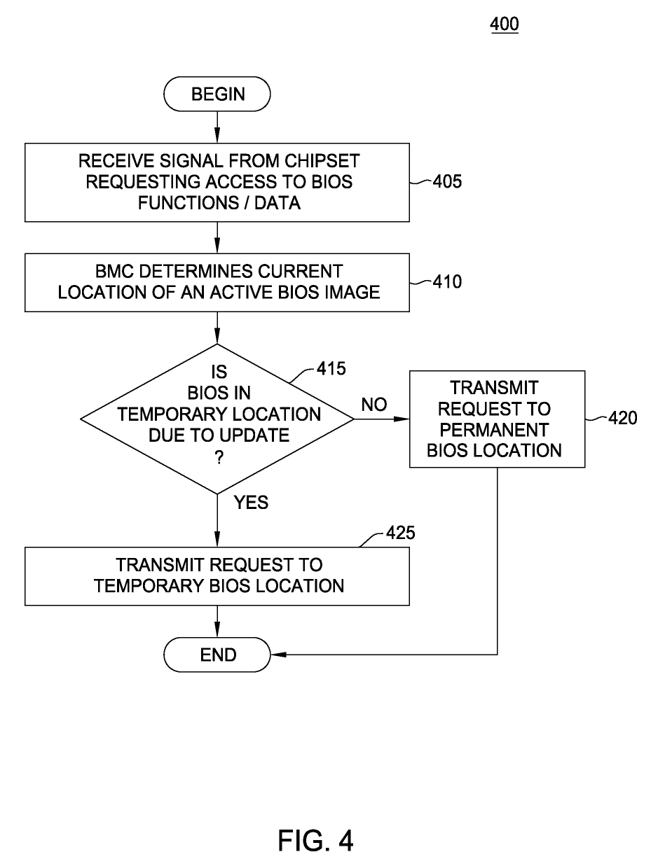

FIG. 4 is a flow diagram illustrating a method 400 for accessing BIOS functions and/or data using a virtual memory, according to one embodiment of the invention. As shown, the method 400 begins at step 405, where the chipset (e.g., the northbridge) sends a signal requesting access to BIOS functions or data. In one embodiment, the BMC may receive the request normally destined for the permanent location (e.g., a flash memory) and redirect the request to the location of the virtual memory (e.g., a region of system memory, SDRAM, or other temporary location). Accordingly, at step 410 the BMC determines a current location of an active BIOS image. At step 415, the BMC may determine whether the BIOS is in a temporary location due to an update. If so, at step 425, then the requested information or BIOS functions may be accessed using the temporary BIOS location (i.e., from the virtual memory). In such a case, it is assumed that the method for updating a BIOS on a server system using a virtual memory update shown in FIG. 3 has been performed and that the BIOS image and data currently reside in a virtual memory location. Otherwise, if the BIOS is in the regular location (i.e., an update has not occurred), then at step 425, the requested information or BIOS functions may be accessed using the regular BIOS location.

Advantageously, embodiments of the invention allow an administrator to update a BIOS image stored in a flash memory using a baseboard management controller (BMC). For example, the BMC may be accessed using one of a variety of IPMI channels, such as IPMI over LAN, over a UART (i.e., a serial connection), over a KCS (keyboard control style) communications channel, or an IPMB (Intelligent Platform Management Bus). The administrator may update a BIOS image from a location remote to the server, by accessing the BMC using IPMI over LAN. Of course, the LAN (and other) IPMI channels may be used in cases where the administrator and the server are in a common location.

Once copied, requests made by elements of the server to access BIOS functions or data are sent to the BIOS image stored in the temporary location. That is, the copied BIOS image provides a virtual memory for BIOS operations carried out by the server. Further still, the updated BIOS image may be stored in the regular BIOS storage container. In one embodiment, once the updated BIOS is stored in the BIOS storage container, requests for BIOS information and/or data may be directed to the updated BIOS. Alternatively, the server may continue to operate using the BIOS in the temporary location until being restarted. Doing so may allow the server to be updated at one time and continue using the original BIOS until the server is restarted at a convenient time.

While the foregoing is directed to embodiments of the present invention, other and further embodiments of the invention may be devised without departing from the basic scope thereof, and the scope thereof is determined by the claims that follow.

What is claimed is:

1. A method for updating a BIOS image on a computer system, comprising:
receiving, by a service processor, an updated BIOS image over a communications channel;
moving a current BIOS image from a first storage location to a second storage location;
moving the updated BIOS image to the first storage location;
receiving, from a chipset coupled to the service processor, a request to access the BIOS image on the server system; and
directing, by the service processor, the request to access the BIOS image to the BIOS image in the second storage location.

2. The method of claim 1, wherein the communications channel is an IPMI channel used to transmit IPMI messages to a service processor receiving the updated BIOS image.

3. The method of claim 2, wherein the IPMI channel is one of an IPMI over LAN channel, a UART channel, a keyboard control style (KCS) communications channel, and an Intelligent Platform Management Bus (IPMB) channel.

4. The method of claim 2, wherein the service processor is a baseboard management controller (BMC).

5. The method of claim 1, wherein at least one of the first storage location and the second location is within a region of flash memory.

6. The method of claim 1, wherein at least one of the first storage location and the second location is within a region of NVRAM memory.

7. The method of claim 1, wherein at least one of the first location and the second storage location is within a region of SDRAM memory.

8. A computer-readable storage medium containing a program which, when executed, performs an operation for updating a BIOS image on a computer system, the operation comprising:
receiving an updated BIOS image over a communications channel;
moving a current BIOS image from a first storage location to a second storage location;
moving the updated BIOS image to the first storage location;
receiving a request to access the BIOS image on the server system; and
directing the request to access the BIOS image to the BIOS image in the second storage location.

9. The computer-readable storage medium of claim 8, wherein the communications channel is an IPMI channel used to transmit IPMI messages to a service processor receiving the updated BIOS image.

10. The computer-readable storage medium of claim 9, wherein the IPMI channel is one of an IPMI over LAN channel, a UART channel, a keyboard control style (KCS) communications channel, and an Intelligent Platform Management Bus (IPMB) channel.

11. The computer-readable storage medium of claim 9, wherein the service processor is a baseboard management controller (BMC).

12. The computer-readable storage medium of 11, wherein the program is a firmware image for the BMC.

13. The computer-readable storage medium of claim 8, wherein at least one of the first storage location and the second location is within a region of flash memory.

14. The computer-readable storage medium of claim 8, wherein at least one of the first storage location and the second location is within a region of NVRAM memory.

15. The computer-readable storage medium of claim 8, wherein at least one of the first location and the second storage location is within a region of SDRAM memory.

16. A computer system, comprising,
a memory storing a current BIOS image;
a processor; and
a service processor containing a firmware image configured to perform an operation for updating the current BIOS image on the computer system; and
at least one IPMI communications channel configured to communicate with the service processor to supply an updated BIOS image to the service processor over the IPMI channel.

17. The computer system of claim 16, wherein the operation performed by the firmware image comprises:
receiving, by the service processor, the updated BIOS image over the IPMI communications channel;
moving the current BIOS image from a first storage container to a second storage container;
moving the updated BIOS image to the first storage container;
receiving, from a chipset coupled to the service processor, a request to access the current BIOS image on the server system; and
directing, by the service processor, the request to access the current BIOS image to the BIOS image in the second storage container.

18. The computer system of claim 17, wherein the first storage container comprises at least one of a region of flash memory, a region of NVRAM memory or a region of SDRAM memory; and wherein the second storage container comprises at least one of a region of flash memory, a region of NVRAM memory or a region of SDRAM memory.

19. The computer system of claim 16, wherein the IPMI channel is one of an IPMI over LAN channel, a UART channel, a keyboard control style (KCS) communications channel, and an Intelligent Platform Management Bus (IPMB) channel.

20. The computer system of claim 16, wherein the service processor is a baseboard management controller (BMC).
